(19) United States
(12) Patent Application Publication
(10) Pub. No.: US 2003/0023704 A1
(43) Pub. Date: Jan. 30, 2003

(54) Wireless information home appliance system

(75) Inventors: Chung-Wang Lee, Hsinchu (TW); Yi Liu, Hsinchu (TW)

Correspondence Address: BACON & THOMAS, PLLC, 625 SLATERS LANE, FOURTH FLOOR, ALEXANDRIA, VA, 22314

(73) Assignee: D-Link Corporation, Hsinchu (TW)

(21) Appl. No.: 09/912,511

(22) Filed: Jul. 26, 2001

(51) Int. Cl. G06F 15/16

(52) U.S. Cl. 709/217; 709/203

(57) ABSTRACT

A wireless information home appliance system includes at least one information home appliance, and a center controller connected to a network and adapted to receive and detect output signal of wireless I/O circuit of each appliance, to register the connection of the appliance to the network, and to regularly inquire the condition of each appliance. When received a packet message from the network, the center controller sends the packet message to the I/O circuit of each appliance by broadcast. The I/O circuit of each appliance demodulates the packet message signal upon receipt of the same from the center controller, and proceeds with the required control processing subject to the control instruction of the packet message signal if the signal matches.

### BACKGROUND OF THE INVENTION

(1) Field of the Invention

The present invention relates to electric home appliance systems and, more particularly to a wireless information home appliance system.

(2) Prior Art

A regular information home appliance system, as shown in FIG. 1, comprises an information home appliance 2, and a network 1 arranged in the house and adapted to connect the information hole appliance 2 to the Internet for enabling a remote electronic apparatus, for example, a personal computer, personal digital assistant, or the like to control the operation of the information home appliance 2. The information home appliance 2 comprises a control circuit 20 adapted to control the operation of component parts of the information home appliance 2, a signal receiver 22, and a connector 24 connected to the network 1. The signal receiver 22 comprises a CPU 222, and a network interface 224 connected between the connector 24 and the CPU 222. The CPU 222 receives and demodulates packet message signal from the network 1 through the network interface 224 via the connector 24, and transmits received packet message signal to the control circuit 20, causing the control circuit 20 to control the operation of the information home appliance 2 subject to the control instruction of received packet message signal. Because this information home appliance system is a wired system, complicated wiring arrangement is needed to connect the information home appliance 2 to the network 1. When changing the location of the information home appliance 2 in the house, the wiring of the network 1 must be re-arranged. Therefore, it is complicated to change the location of the information home appliance 2.

### SUMMARY OF THE INVENTION

The present invention provides a wireless information home appliance system, which eliminates the aforesaid problem. According to one aspect of the present invention, the wireless information home appliance system is comprised of at least one information home appliance, and a center controller. Each information home appliance and the center controller have a respective I/O circuit. The center controller is connected to the network, and adapted to automatically receive and detect signal outputted from the wireless I/O circuit of each information home appliance, to register the connection of each information home appliance to the network, and to regularly inquire the condition of each information home appliance. According to another aspect of the present invention, when received a packet message from the network, the center controller sends the packet message to the wireless I/O circuit of each information home appliance by broadcast. Upon receipt of a packet message signal from the center controller, the wireless I/O circuit of the information home appliance demodulates the packet message signal, and proceeds with the required control processing subject to the control instruction of the packet message signal if the signal matches.

### BRIEF DESCRIPTION OF THE DRAWINGS

FIG. 1 is a system block diagram of an information home appliance system constructed according to the prior art.

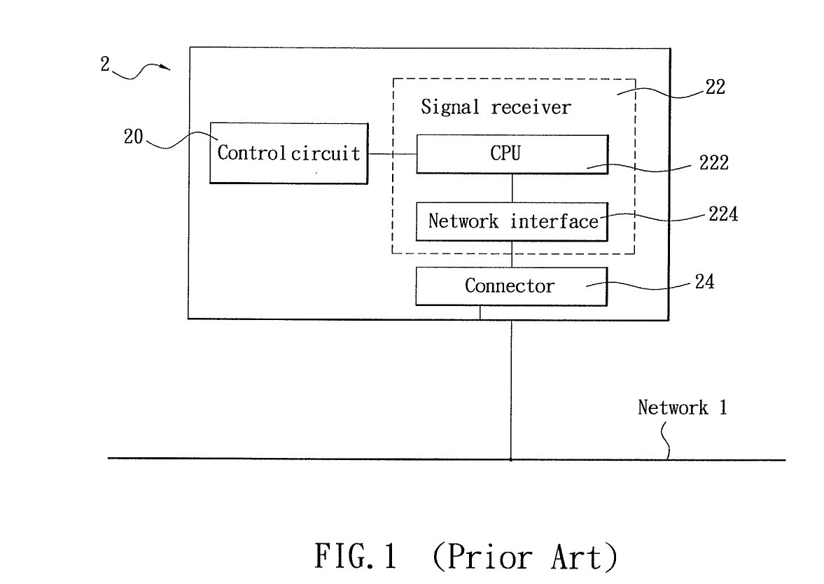

FIG. 2 is a system block diagram of a wireless information home appliance system constructed according to the present invention.

FIG. 3 illustrates the operation flow of the center controller of the wireless information home appliance system according to the present invention.

FIG. 4 shows an application example of the present invention.

### DETAILED DESCRIPTION OF THE PREFERRED EMBODIMENT

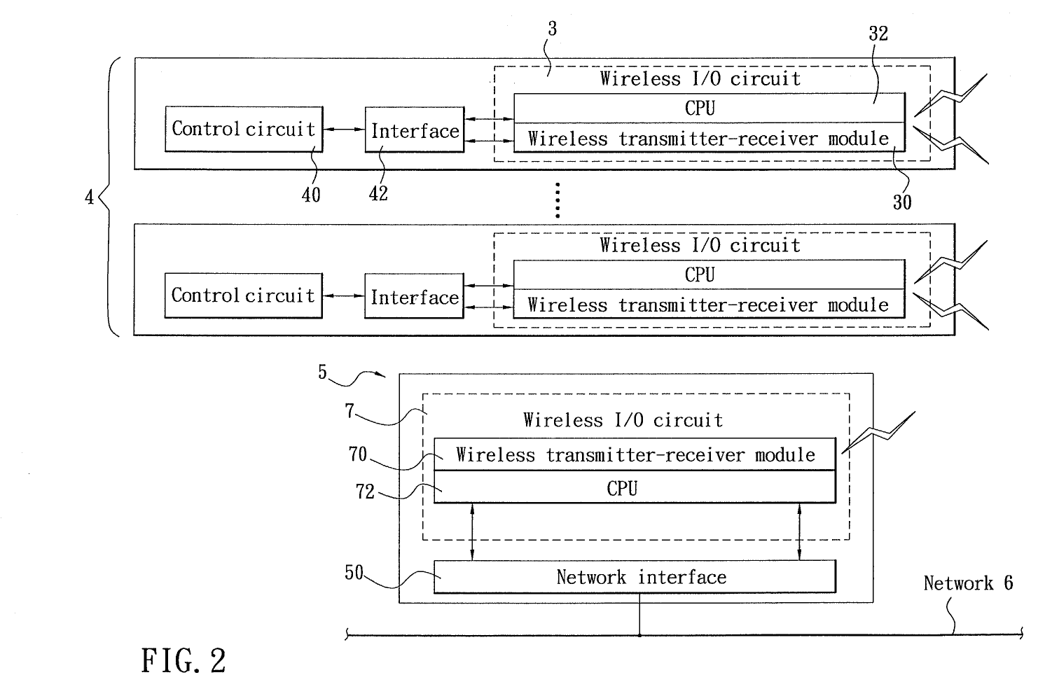

Referring to FIG. 2, a wireless information home appliance system in accordance with the present invention comprises at least one, for example, a plurality of information home appliances 4, and a center controller 5. Each information home appliance 4 comprises a wireless I/O (input/output) circuit 3. The center controller 5 is connected to the network 6, comprising a wireless I/O circuit 7. When started, the center controller 5 automatically receives and detects output signal of the wireless I/O circuit 3 of each of the information home appliances 4, and then registers the connection of the information home appliances 4 to the network and regularly inquires the condition of the information home appliances 4. When received a packet message from the network 6, the center controller 5 immediately sends the packet message through its wireless I/O circuit 7 to the wireless I/O circuit 3 of each of the information home appliances 4 by broadcast. Upon receipt of the packet message, the wireless I/O circuit 3 of each information home appliance 4 demodulates the signal of the packet message, and judges if the signal matches or not. If the signal matches, the respective information home appliance 4 proceeds with the required control processing subject to the control instruction of the packet message. Thus, no wiring is needed to connect every information home appliance 4 to the network and, the user can control every information hole appliance 4 from a remote end of the network by means of wireless transmission.

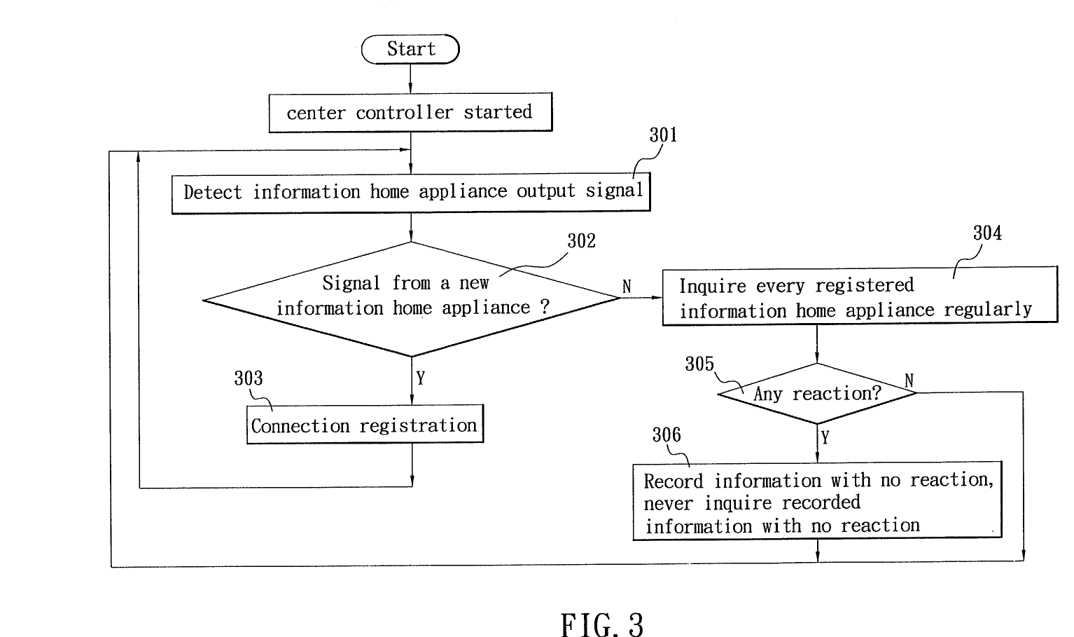

Referring to FIG. 3, according to the present invention, the center controller 5, when started, recognizes the information home appliances 4 subject to the following procedure.

(301) At first, the center controller 5 automatically receives and detects output signal of the wireless I/O circuit 3 of each of the information home appliances 4;

(302) Upon receipt of a signal, the center controller 5 judges if the signal came from the wireless I/O circuit 3 of a new information home appliance 4 or not;

(303) If the information home appliance 4 under detection is newly installed, the center controller 5 registers the PIN (personal identification number) code of the newly installed information home appliance 4 in its memory for further recognition use and then returns to step (301);

(304) If the information home appliance 4 under detection is not a new one, the center controller 5 keeps inquiring every registered information home appliance 4 regularly and proceeding the following steps;

(305) The center controller 5 judges if the information home appliances 4 have reaction or not subject to their response signal;

(306) If the inquired information home appliance 4 has no reaction, the center controller 5 records the PIN code of the information home appliance having no reaction so as not to make any further inquiry, and then returns to step (301); if every inquired information home appliance 4 has a reaction, the center controller 5 returns to step (301).

Referring to FIG. 2 again, the basic configuration and circuit construction of the information home appliances 4 are similar to regular commercially available information home appliances. Each information home appliance 4 further comprises a control circuit 40 adapted to control every component part of the respective information home appliance, and an interface 42 connected to its wireless I/O circuit 3. According to the present invention, the wireless I/O circuit 3 is adapted to receive and demodulate every packet message transmitted by the center controller 5, to judge if the signal matches or not. If the signal of a packet message transmitted by the center controller 5 matches, the wireless I/O circuit 3 of the respective information home appliance 4 proceeds the required control processing subject to the control instruction of the packet message, and then transmits a response signal to the center controller 5 for recognition of the processing status.

The wireless I/O circuit 3 is comprised of a CPU 30 and a wireless transmitter-receiver module 32. The CPU 30 is connected to the wireless transmitter-receiver module 32 and the interface 42 respectively, and adapted to receive signal from the control circuit 40 and to transmit received signal to the wireless transmitter-receiver module 32 for transmission to the center controller 5. The CPU 32 transmits control signal received by the wireless transmitter-receiver module 32 through the interface 42 to the control circuit 40, causing the control circuit 40 to control the component parts of the respective information home appliance 4.

According to the present invention, the center controller 5 is comprised of a wireless I/O circuit 7 and a network interface 50. The center controller 5 is connected to the network 6 through the network interface 60, so as to receive signal from the remote side, and to transmit signal to the other electronic apparatus at the remote side. The wireless I/O circuit 7 of the center controller 5 is comprised of a CPU 72 and a wireless transmitter-receiver module 70. The CPU 72 receives control signal from the remote side through the network interface 50, and then transmits received signal to the information home appliances 4 through the wireless transmitter-receiver module 70. The CPU 72 also transmits response signal received by the wireless transmitter-receiver module 70 from every information home appliance 4 to the other electronic apparatus at the remote side of the network through the network interface 50.

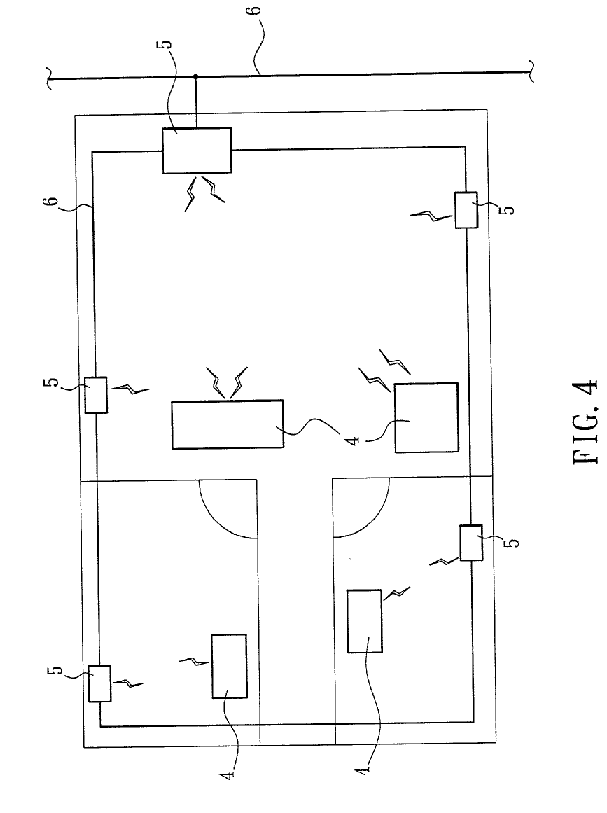

Because the invention employs a regular wireless transmitting-receiving method to control the information home appliances 4, signal receiving and transmitting is restricted to a limited distance and tends to be blocked by partition walls. The arrangement shown in FIG. 4 eliminates these problems, i.e., a respective center controller 5 is installed in every room of the building and respectively connected to the network 6 to receive control signal from the remote side of the network 6. Because every packet message is transmitted from the network 6 to the information home appliances 4 by broadcast, the center controller 5 in every room of the building will receive every packet message from the network 6. Upon receive of a packet message, the center controller 5 in every room of the building immediately transmits the signal into the air by broadcast. Upon receive of a packet message signal, the information home appliance immediately judges if the signal matches. If the signal does not match, the information home appliance gives up the signal. Every information home appliance runs the operation control subject to the nature of the control instruction of the signal received only when the signal received is matched. By means of the aforesaid features, the invention enables the user to control all information home appliances in his (her) house from a remote side of the network.

A prototype of wireless information home appliance system has been constructed with the features of FIGS. 2˜4. The wireless information home appliance system functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A wireless information home appliance system comprising at least one information home appliance, said at least one information home appliance each having a wireless I/O (input/output) circuit, and a center controller connected to a network, said center controller comprising a wireless I/O (input/output) circuit, wherein when started, said center controller automatically receives and detects output signal of the wireless I/O circuit of each of said at least one information home appliance, and then registers the connection of said at least one information home appliance to said network and regularly inquires the condition of said at least one information home appliance; when received a packet message from said network, said center controller immediately sends the packet message to the wireless I/O circuit thereof to the wireless I/O circuit of each of said at least one information home appliance by broadcast; upon receipt of a packet message signal from said center controller, the wireless I/O circuit of each of said at least one information home appliance demodulates the packet message signal, and judges if the signal matches or not, and the proceeds with the required control processing subject to the control instruction of the packet message signal if the signal matches.

2. The wireless information home appliance system of claim 1 wherein said center controller, when started, proceeds with the steps of: (a) automatically receiving and detecting output signal of the wireless I/O circuit of each of said at least one information home appliance, (b) judging if the signal received came from a new information home appliance or not, (c) registering the PIN (personal identification number) code of the information home appliance in a memory thereof for further recognition use and then returning to step (a) if the information home appliance under detection is newly installed.

3. The wireless information home appliance system of claim 2 wherein if the information home appliance under detection is not a new one, said center controller keeps inquiring the current condition of every registered information home appliance, and then judging if said at least one information home appliance have reaction or not subject to their response signal, and then recording the PIN code of the information home appliance having no reaction so as not to make any further inquiry If the inquired information home appliance has no reaction, and then returns to step (a).

4. The wireless information home appliance system of claim 1 wherein said at least one information home appliance each further comprises a control circuit adapted to control every component part of the respective information home appliance, and an interface connected to the respective wireless I/O circuit for receiving and transmitting signal through the respective wireless I/O circuit.

5. The wireless information home appliance system of claim 4 wherein the wireless I/O circuit of each of said at least one information home appliance comprises a wireless transmitter-receiver module and a CPU (central processing unit) connected to the wireless transmitter-receiver module of the respective wireless I/O circuit and the interface of the respective information home appliance respectively and adapted to receive signal from the control circuit of the respective information home appliance and transmit received signal to the wireless transmitter-receiver module of the respective wireless I/O circuit for transmission to said center controller, and to transmit control signal received by the wireless transmitter-receiver module of the respective wireless I/O circuit through the respective interface to the control circuit of the respective information home appliance to drive the control circuit to control the component parts of the respective information home appliance.

6. The wireless information home appliance system of claim 1 wherein said center controller further comprises a network interface connected to said network for receiving packet message signal from a remote side at said network and transmitting signal to electronic apparatus means at a remote side of said network.

7. The wireless information home appliance system of claim 6 wherein the wireless I/O circuit of said center controller comprises a wireless transmitter-receiver module, and a CPU (central processing unit) adapted to receive packet message signal from a remote side of said network through the network interface of said center controller and transmit received packet message signal to said at least one information home appliance through the wireless transmitter-receiver module of said center controller, and to transmit signal from the wireless-transmitter-receiver module of said center controller to electronic apparatus means at a remote side of said network through the network interface of said center controller.

8. The wireless information home appliance system of claim 5 wherein when the CPU of the wireless I/O circuit of one of said at least one information home appliance recognizes received signal not for controlling the respective information home appliance, the CPU of the wireless I/O circuit of the respective information home appliance gives up the packet message.

9. The wireless information home appliance system of claim 5 wherein the wireless transmitter-receiver module of the wireless I/O circuit of each of said at least one information home appliance is an infrared transmitter-receiver module.

10. The wireless information home appliance system of claim 7 wherein the wireless transmitter-receiver module of the wireless I/O circuit of said center controller is an infrared transmitter-receiver module.

11. The wireless information home appliance system of claim 5 wherein the wireless transmitter-receiver module of the wireless I/O circuit of each of said at least one information home appliance is a transmitter-receiver module constructed subject to bluetooth communication protocol.

12. The wireless information home appliance system of claim 7 wherein the wireless transmitter-receiver module of the wireless I/O circuit of said center controller is a transmitter-receiver module constructed subject to bluetooth communication protocol.
